SEQUENCE LISTING (3 sequences)

SEQ ID NO: 1 - DNA, 24 bp, Artificial Sequence
  Synthetic Polynucleotide
ggcgatcgagaattctcgatcgcc

SEQ ID NO: 2 - DNA, 30 bp, Artificial Sequence
  Synthetic Polynucleotide
acgacggccagttaattcgagctcggtacc

SEQ ID NO: 3 - DNA, 30 bp, Artificial Sequence
  Synthetic Polynucleotide
acgacggccagtcttaaggagctcggtacc

(19) United States
(12) Patent Application Publication
(10) Pub. No.: US 2010/0314250 A1
(43) Pub. Date: Dec. 16, 2010

(54) STABILIZATION OF COMPLEXES FOR GEL MOBILITY SHIFT, CHROMATOGRAPHY, AND CAPILLARY ELECTROPHORESIS

(75) Inventors: Nina Y. Sidorova, North Potomac, MD (US); Donald C. Rau, Rockville, MD (US)

Correspondence Address: LEYDIG, VOIT & MAYER, LTD., TWO PRUDENTIAL PLAZA, SUITE 4900, 180 NORTH STETSON AVENUE, CHICAGO, IL, 60601-6731, US

(73) Assignees: The United States of America, as represented by the Secretary, Department of; Health and Human Services,, Bethesda, MD (US)

(21) Appl. No.: 12/485,481

(22) Filed: Jun. 16, 2009

(51) Int. Cl. B01D 57/02; B01D 15/08

(52) U.S. Cl. 204/451; 204/469; 210/635

(57) ABSTRACT

The invention provides a method of separating a complex comprising a first agent bound to a second agent from unbound agents comprising (a) preparing a gel comprising a gel matrix and a neutral solute, (b) placing one or more samples comprising the complex and unbound agents on the gel, and (c) applying an electrophoresis voltage across the gel and separating the complex from the unbound agents. The invention also provides methods of separating a complex comprising a first agent bound to a second agent from unbound agents by chromatography and capillary electrophoresis.

### BACKGROUND OF THE INVENTION

Electrophoretic mobility shift assays (EMSAs), capillary electrophoresis, and chromatography are useful techniques for analyzing and separating unbound agents from complexes of first agent (e.g., a nucleic acid, protein, drug, ligand, or target molecule) that is bound to a second agent. For example, EMSA uses gel electrophoresis to separate complexes (e.g., DNA-protein or RNA-protein complexes) from unbound agents, e.g., free DNA or RNA. Chromatography separates complexes of bound agents from unbound agents by relying on the differential affinities of the bound and unbound agents for a mobile phase and for a stationary phase. Capillary electrophoresis (CE) separates complexes of bound agents from unbound agents by using gel or liquid-based electrophoresis in capillaries.

EMSA, chromatography, and CE can also be used to study interactions of various agents, for example, protein-nucleic acid interactions (Molloy, P. L., Methods Mol. Biol. 130: 235-246 (2000); Hegarat, N. et al., Biochimie 90: 1265-1272 (2008); Vigneault, F. et al., Expert Rev. Proteomics 2, 705-718 (2005); Kerr, L. D., Enzymology 254, 619-632 (1995)). Illustratively, these techniques can be used to study the binding of repair proteins, polymerases, restriction endonucleases, transcription factors and other gene regulatory proteins to DNA and to identify unknown proteins that bind specifically to the promoter and enhancer regions.

The dissociation of bound complexes during analysis can make it difficult to quantitate and analyze complexes. Accordingly, there is a need in the art for improved methods of separating complexes of weakly bound agents from unbound agents.

### BRIEF SUMMARY OF THE INVENTION

In an embodiment, the invention provides a method of separating unbound agents from a complex comprising a first agent bound to a second agent comprising (a) preparing a gel comprising a gel matrix and a neutral solute selected from the group consisting of stachyose, a glucoside, an amine oxide, a betaine, triethylene glycol, sorbitol, ethylene glycol, threitol, xylitol, and ectoine (b) placing one or more samples comprising the complex and unbound agents on the gel, and (c) applying an electrophoresis voltage across the gel and separating the complex from the unbound agents.

In another embodiment, the invention provides a method of separating unbound agents from a complex comprising a first agent bound to a second agent by chromatography comprising (a) preparing a stationary phase comprising a neutral solute selected from the group consisting of stachyose, a glucoside, an amine oxide, a betaine, triethylene glycol, sorbitol, ethylene glycol, threitol, xylitol, and ectoine, (b) combining a mobile phase with a sample comprising the complex and unbound agents, (c) placing the mobile phase comprising the sample in the stationary phase, and (d) moving the mobile phase through the stationary phase and separating the complex from the unbound agents by chromatography.

In still another embodiment, the invention provides a method of separating unbound agents from a complex comprising a first agent bound to a second agent by capillary electrophoresis comprising (a) preparing a buffer comprising a neutral solute selected from the group consisting of stachyose, a glucoside, an amine oxide, a betaine, triethylene glycol, sorbitol, ethylene glycol, threitol, xylitol, and ectoine, (b) placing the buffer in a capillary of a capillary electrophoresis apparatus, (c) placing a sample comprising the complex and unbound agents in the capillary, (d) applying an electrophoresis voltage along the capillary and separating the complex from the unbound agents by capillary electrophoresis.

### BRIEF DESCRIPTION OF THE SEVERAL VIEWS OF THE DRAWING(S)

FIG. 1 shows a gel in which EcoRI protein bound to a non-specific DNA sequence is loaded onto a 10% polyacrylamide gel without neutral solute (Lane 1) or a 10% polyacrylamide gel containing 30% triethylene glycol (Lane 2).

FIGS. 2(a)-(c) shows 10% polyacrylamide gels (1×TAE) containing (a) 10% triethylene glycol, (b) 20% triethylene glycol, or (c) 30% triethylene glycol on which EcoRT protein bound to a specific DNA sequence (Lane 1), a noncognate ‘star’ DNA sequence (Lane 2) or a non-specific DNA sequence (Lane 3) is loaded.

FIG. 3 shows a lane intensity profile measured by distance electrophoresed (X axis) and fluorescence intensity (Y axis) for a gel in which EcoRI protein bound to a specific sequence (top panel) or a ‘star’ DNA sequence (bottom panel) is loaded onto a 10% polyacrylamide gel (1×TAE) containing no neutral solute.

FIG. 4 shows a lane intensity profile measured by distance electrophoresed (X axis) and fluorescence intensity (Y axis) for a gel in which EcoRI protein bound to a ‘star’ DNA sequence is loaded onto a 10% polyacrylamide gel (1×TAE) containing 10% triethylene glycol (top panel), 20% triethylene glycol (middle panel), or 30% triethylene glycol (bottom panel).

### DETAILED DESCRIPTION OF THE INVENTION

According to an embodiment of the invention, a method of separating unbound agents from a complex comprising a first agent bound to a second agent comprises (a) preparing a gel comprising a gel matrix and a neutral solute selected from the group consisting of sucrose, stachyose, a glucoside, an amine oxide, a betaine, triethylene glycol, sorbitol, ethylene glycol, threitol, xylitol, and ectoine (b) placing one or more samples comprising the complex and unbound agents on the gel, and (c) applying an electrophoresis voltage across the gel and separating the complex from the unbound agents.

The complex comprises any first agent that binds to any second agent. Exemplary first and second agents include nucleic acids (e.g., DNA and RNA), proteins (as used herein, “protein” also includes polypeptides and antibodies), drugs, ligands, and target molecules. In one embodiment, the first agent may be a protein that binds to a second agent that may be another protein, a nucleic acid, a drug, or a ligand. In another embodiment, the first agent may be a nucleic acid (e.g., a DNA molecule) that binds to a second agent that may be a ligand or a drug. In still another embodiment, the first agent may be a ligand that binds to a target molecule. In this regard, the complex may comprise any of, for example, protein-protein complexes, protein-DNA complexes, protein-RNA complexes, protein-drug complexes, protein-ligand complexes, DNA-ligand complexes, RNA-ligand complexes, DNA-drug complexes, and RNA-drug complexes, and ligand-target molecule complexes.

In one embodiment, the first agent is weakly bound to the second agent. Weakly bound complexes are labile, i.e., subject to dissociate in gels, capillary electrophoresis buffers, or in chromatography liquid or stationary phases. In this regard, weakly bound complexes include complexes with an association binding constant Kₐ of, for example, less than about 10⁹ M⁻¹ or from about 10³ M⁻¹ to about 10⁶ M⁻¹, under physiological salt and pH conditions (e.g., about 50 mM to about 150 mM salt and about 6.5 to about 7.5 pH).

In an embodiment, the method comprises preparing a gel comprising a gel matrix and a neutral solute. The neutral solute is electrically neutral, i.e., lacks a positive and a negative charge. In one embodiment, the neutral solute is an osmolyte. The neutral solute may be selected from the group consisting of sucrose, stachyose, a glucoside (e.g., α-methyl glucoside), an amine oxide (e.g., trimethylamine oxide), a betaine (e.g., betaine glycine), triethylene glycol, sorbitol, ethylene glycol, threitol, xylitol, ectoine, and glycerol. A preferred neutral solute is triethylene glycol. Triethylene glycol is, advantageously, not particularly viscous and allows suitable electrophoretic velocities.

In one embodiment, the gel comprises about 5% to about 50% neutral solute. In a preferred embodiment, the gel comprises about 10% to about 30% neutral solute. In an especially preferred embodiment, the gel comprises about 20% to about 30% triethylene glycol.

The gel comprises a gel matrix. The gel matrix may be any gel matrix suitable for the particular application. In one embodiment, the gel matrix is polyacrylamide. In another embodiment, the gel matrix is agarose. Other suitable gel matrices include, for example, dextran and combined polyacrylamide-dextran.

Other than including a neutral solute, the gel is otherwise prepared using materials and procedures that are known in the art. See, for instance, Sambrook et al., Molecular Cloning: A Laboratory Manual, 3^{rd} ed., Cold Spring Harbor Press, Cold Spring Harbor, N.Y., 2001; and Ausubel et al., Current Protocols in Molecular Biology, Greene Publishing Associates and John Wiley & Sons, NY, 1994. For example, as well-known in the art, agarose gels are prepared by combining agarose with an electrophoresis buffer, e.g., TAE buffer (Tris-acetate/EDTA), TPE buffer (Tris-phosphate/EDTA), TBE buffer (Tris-borate/EDTA), and a stain (e.g., ethidium bromide). As well-known in the art, polyacrylamide gels are prepared by combining acrylamide/methylenebisacrylamide, water, a polymerization accelerator (e.g., TBE), and a polymerization initiator (e.g., ammonium persulfate). The gels are cast according to procedures known in the art.

In an embodiment, the method further comprises placing one or more samples comprising the complex and unbound agents on the gel. The samples comprising the complex and unbound agents are obtained by combining the first agent with the second agent under suitable binding conditions. Unbound agents may also remain in the sample. The selection of conditions under which the first agent binds to the second agent is within the purview of one of ordinary skill in the art and may be chosen based on the particular agents being studied (see, e.g., Ausubel and Sambrook, supra).

The sample is loaded on the gel and an electrophoresis voltage is applied across the gel as known in the art (see Ausubel and Sambrook, supra). The gel may be immersed in any suitable electrophoresis buffer and the sample may be loaded on the gel in any suitable loading buffer. Preferably, the loading buffer and/or the electrophoresis buffer also comprise neutral solute (e.g., in the percentages described for the gel). In one embodiment, neutral solute is added to the sample wells following immersion of the gel in the electrophoresis buffer. The addition of neutral solute to the loading buffer, to the sample wells, and/or to the electrophoresis buffer advantageously minimizes loss of neutral solute in the gel by diffusion and also minimizes or prevents dissociation of the complex before it enters the gel.

The electrophoresis causes separation of the complex from the unbound agents. The complex and the unbound agent may be visualized on the gel as known in the art (see Ausubel and Sambrook, supra). Upon completion of electrophoresis, the complex and the unbound components are visualized as bands that are clearly separated from one another. In particular, the complex is clearly visible as a band with minimal or no smearing, indicating that the complex is stabile in the gel, i.e., the complex has minimal or no dissociation in the gel. Advantageously, the methods of the invention make it possible to precisely detect, quantitate and/or analyze complexes, particularly weakly bound complexes, that are difficult or impossible to detect, quantitate or analyze due to smearing in gels that lack neutral solute. In this regard, one embodiment of the inventive method further comprises determining the degree of migration of the complex on the gel. The degree of migration on the gel may be determined by any suitable method known in the art (see Ausubel and Sambrook, supra).

In another embodiment, the method further comprises collecting the separated complex and/or the separated unbound agents. The complex and unbound agents may be collected by any suitable method known in the art (see Ausubel and Sambrook, supra).

In one embodiment, the invention provides a gel comprising a gel matrix and a neutral solute selected from the group consisting of stachyose, a glucoside (e.g., a-methyl glucoside), an amine oxide (e.g., trimethylamine oxide), a betaine (e.g., betaine glycine), triethylene glycol, sorbitol, ethylene glycol, threitol, xylitol, and ectoine. The gel comprises the neutral solute in the amounts described herein. The gel matrix may be any suitable gel matrix described herein. Other than the neutral solute, the inventive gel may further include any other components that are known in the art (e.g., buffers, stains, dyes, etc.) and may be prepared as described herein or by any suitable method known in the art.

In another embodiment, the invention provides a method of separating unbound agents from a complex comprising a first agent bound to a second agent by chromatography comprising (a) preparing a stationary phase comprising a neutral solute selected from the group consisting of stachyose, a glucoside, an amine oxide, a betaine, triethylene glycol, sorbitol, ethylene glycol, threitol, xylitol, and ectoine (b) combining a mobile phase with a sample comprising the complex and unbound agents, (c) placing the mobile phase comprising the sample in the stationary phase, and (d) moving the mobile phase through the stationary phase and separating the complex from the unbound agents by chromatography.

The agents may be any of the agents described herein. The chromatography may be any suitable chromatography known in the art, e.g., gel chromatography or liquid chromatography (e.g., high performance liquid chromatography (HPLC) and ÄKTA™ fast protein liquid chromatography (FPLC)).

In an embodiment of the method of separating the complex from unbound agents by chromatography, the method comprises preparing a stationary phase comprising a neutral solute selected from the group consisting of stachyose, a glucoside, an amine oxide, a betaine, triethylene glycol, sorbitol, ethylene glycol, threitol, xylitol, and ectoine. The stationary phase may be any stationary phase known in the art (e.g., a liquid buffer or any suitable gel) that is suitable to the particular chromatography technique being applied and for the particular agents being studied (see Ausubel and Sambrook, supra). The stationary phase comprises any neutral solute described herein. Typically, the stationary phase comprises about 5% to about 50% neutral solute. In a preferred embodiment, the stationary phase comprises about 10% to about 30% neutral solute. In an especially preferred embodiment, the stationary phase comprises about 20% to about 30% triethylene glycol.

In an embodiment of the method of separating the complex from unbound agents by chromatography, the method comprises combining a mobile phase with a sample comprising the complex and unbound agents. The mobile phase may be any suitable mobile phase known in the art (e.g., any suitable mobile phase buffer, (see Ausubel and Sambrook, supra)). Preferably, the mobile phase also comprises neutral solute (e.g., in the percentages described herein). The addition of neutral solute to the mobile phase advantageously minimizes loss of neutral solute in the stationary phase by diffusion and also prevents dissociation of the complex before it enters the stationary phase.

In an embodiment of the method of separating the complex from unbound agents by chromatography, the method comprises placing a mobile phase comprising the sample in the stationary phase and moving the mobile phase through the stationary phase and separating the complex from the unbound agents by chromatography. The mobile phase may be moved through the stationary phase by any method known in the art suitable to the particular chromatography technique being applied and for the particular agents being studied (see Ausubel and Sambrook, supra).

The chromatographic process causes separation of the complex from the unbound agents. As the chromatographic process continues, the complex can be detected and/or collected separately from the unbound components. In particular, the complex is stabile in the stationary phase, i.e., the complex has minimal or no dissociation in the stationary phase. Advantageously, the methods of the invention make it possible to precisely detect, collect, quantitate and/or analyze complexes, particularly weakly bound complexes, that are difficult or impossible to detect, collect, quantitate or analyze due to dissociation of the complex in stationary phases that lack neutral solute. In this regard, one embodiment of the inventive method further comprises collecting the separated complex and/or the separated bound agents. The separated complex and the separated bound agents may be collected by any suitable method known in the art (see Ausubel and Sambrook, supra).

In another embodiment, the method further comprises determining the degree of migration of the complex on the stationary phase. The degree of migration of the complex on the stationary phase may be determined by any method known in the art (see Ausubel and Sambrook, supra).

In still another embodiment, the invention provides a method of separating unbound agents from a complex comprising a first agent bound to a second agent by capillary electrophoresis (CE) comprising (a) preparing a buffer comprising a neutral solute selected from the group consisting of stachyose, a glucoside, an amine oxide, a betaine, triethylene glycol, sorbitol, ethylene glycol, threitol, xylitol, and ectoine, (b) placing the buffer in a capillary of a capillary electrophoresis apparatus, (c) placing a sample comprising the complex and unbound agents in the capillary, and (d) applying an electrophoresis voltage along the capillary and separating the complex from the unbound agents by CE. The agents may be any of the agents described herein.

In an embodiment of the method of separating the complex from unbound agents by CE, the method comprises preparing a buffer comprising a neutral solute selected from the group consisting of stachyose, a glucoside, an amine oxide, a betaine, triethylene glycol, sorbitol, ethylene glycol, threitol, xylitol, and ectoine. The buffer may be any CE buffer known in the art that is suitable for the particular CE technique being applied and for the particular agents being studied (e.g., an electrolyte buffer) (see Ausubel and Sambrook, supra). The CE buffer comprises any of the neutral solutes described herein. Typically, the CE buffer comprises about 5% to about 50% neutral solute. In a preferred embodiment, the CE buffer comprises about 10% to about 30% neutral solute. In an especially preferred embodiment, the CE buffer comprises about 20% to about 30% triethylene glycol.

In an embodiment of the method of separating the complex from unbound agents by CE, the method comprises placing the buffer in a capillary of a capillary electrophoresis (CE) apparatus. The CE apparatus may be any suitable CE apparatus known in the art (see Ausubel and Sambrook, supra) and may comprise a capillary, a high voltage supply, outlet and inlet containers, and a detector. The capillary may be uncoated or coated with any of a variety of materials (e.g., silica or polyimide), as known in the art. The capillary may be filled with a liquid CE buffer alone or, alternatively or additionally, a substrate such as polyacrylamide, SDS-polyacrylamide, as known in the art. The coating and substrate, if present, preferably also comprises neutral solute (e.g., in the amounts described herein). The addition of neutral solute to the substrate and/or coating in CE advantageously minimizes loss of neutral solute in the CE buffer by diffusion and also minimizes or prevents dissociation of the complex.

In an embodiment of the method of separating the complex from unbound agents by CE, the method comprises placing a sample comprising the complex and unbound agents in the capillary and applying an electrophoresis voltage along the capillary and separating the complex from the unbound agents by CE. The electrophoresis voltage is applied along the capillary as known in the art (see Ausubel and Sambrook, supra).

The CE causes separation of the complex from the unbound agents. As the CE process continues, the complex can be detected and/or collected separately from the unbound components. In particular, the complex is stabile in the CE buffer, i.e., the complex has minimal or no dissociation in the CE buffer. Advantageously, the methods of the invention make it possible to precisely detect, collect, quantitate and/or analyze complexes, particularly weakly bound complexes, that are difficult or impossible to detect, collect, quantitate or analyze due to dissociation of the complex in CE buffers that lack neutral solute. In this regard, one embodiment of the inventive method further comprises collecting the separated complex and/or the separated bound agents. The separated complex and the separated bound agents may be collected by any suitable method known in the art (see Ausubel and Sambrook, supra).

The methods of the invention advantageously stabilize complexes of a first agent bound, particularly weakly bound, to a second agent for gel mobility shift, chromatography, and capillary electrophoresis. Stabilization of the complex minimizes or prevents the dissociation of the first agent from the second agent. In this regard, the methods of the invention stabilize complexes with an association binding constant K, that is, for example, less than about 10⁹ M⁻¹ or from about 10³ M⁻¹ to about 10⁶ M⁻¹, under physiological salt and pH conditions (e.g., about 50 mM to about 150 mM salt and about 6.5 to about 7.5 pH).

Without being bound to a particular theory, it is believed that the dissociation of the complex in a gel exposes the surface area of the agents (e.g., DNA and/or protein) that was previously buried in the bound complex. It is believed that the stabilizing effect of neutral solutes on bound complexes can be explained by the exclusion of neutral solutes from exposed surfaces of the agent. This exclusion may be due to both neutral solute size (a crowding effect) and to a preference of both agents (e.g., DNA and proteins) for water rather than for neutral solutes. It is believed that the surface hydration energies of the neutral solute and the agent are much more favorable than the direct interactions of neutral solute with the agent. It is believed that excluding this neutral solute from agent surfaces causes an inclusion of water, thus stabilizing the complex. The energetic consequences of neutral solute exclusion can be calculated as an osmotic work. If the volume of included water per unit surface area of agent is V_{w} and the osmotic pressure of the neutral solute excluded from this water is Πₛ, then the energy per unit surface area for the exclusion of neutral solute from agent is Πₛ*V_{w}. The extent of exclusion, V_{w}, depends sensitively on the nature of the neutral solute through the neutral solute-agent interaction energies.

In this regard, the invention provides a method of stabilizing a complex of a first agent bound to a second agent in a gel, a chromatography stationary phase, or a capillary electrophoresis buffer comprising any of the methods described herein.

The following examples further illustrate the invention but, of course, should not be construed as in any way limiting its scope.

### EXAMPLE 1

This example demonstrates a method of separating a complex comprising a first agent bound to a second agent from unbound agent.

Triethylene glycol is purchased from Fluka® Chemical Corp. and glycerol from Invitrogen™. The sequences of the double-stranded 24 and 30 bp long oligonucleotides in the binding experiments are shown in Table 1:

TABLE 1

| | | |
|---|---|---|
| Specific Sequence | GAATTC oligo | GGCGATCGAGAATTCTCGA |
| | | TCGCC |
| ‘Star’ Sequence | TAATTC oligo | ACGACGGCCAGTTAATTCG |
| | | AGCTCGGTACC |
| Nonspecific | CTTAAG oligo | ACGACGGCCAGTCTTAAGG |
| Sequence | | AGCTCGGTACC |

The specific sequence oligonucleotide contains the EcoRI cognate recognition site, GAATTC (in bold). The TAATTC oligonucleotide contains a first base pair substitution of the recognition sequence and is commonly termed a ‘star’ site. In the nonspecific oligonucleotide, the ‘star’ sequence is replaced by an inverted specific sequence (CTTAAG) or a nonspecific site with all six base pairs replaced. EcoRI binds ˜1-2×10⁴—fold weaker to nonspecific oligonucleotides than to the specific recognition site. EcoRl binds only about ˜2-6 fold stronger to the TAATTC ‘star’ sequence than to nonspecific sequences (Sidorova et al., Biophys. Journal 87: 2564-76 (2004); Lesser, et al., Science 250, 776-786 (1990); Sidorova et al.,. Proc. Natl. Acad. Sci. USA 93, 12272-12277 (1996).

The oligonucleotides are hybridized and purified as described previously in Sidorova et al., Biophys. Journal 87: 2564-76 (2004). Highly purified EcoRI is a gift from Dr. L. Jen-Jacobson.

The EcoRI-DNA binding buffer includes 20 mM ImidazoleCl (pH 7.0), 20% (v/v) triethylene glycol, 2 mM DTT, 1 mM ethylenediaminetetraacetic acid (EDTA), and 0.02% nonyl phenoxylpolyethoxylethanol (NP-40). The salt concentration is 50 mM NaCl for the ‘star’ and nonspecific sequence complexes and 80 mM NaCl for the specific site oligonucleotide. The conditions are chosen to give stoichiometric binding of protein to the specific, ‘star’ and nonspecific sequence DNA oligonucleotides (see, Sidorova, N. Y. et al., J. Mol. Biol. 310: 801-816 (2001)). The concentrations of protein and DNA are ˜80 nM EcoRI and 160 nM oligonucleotide. Enough neutral solute and Ficoll® are added to the sample wells before loading the samples onto the gel to ensure the density of the sample is greater than the density of neutral solute in the electrophoretic wells. The samples are loaded into the wells with added triethylene glycol to prevent complex dissociation before entering the gel (Sidorova, N. Y. et al., J. Mol. Biol. 310: 801-816 (2001); Rau, D. C., J. Mol. Biol. 361: 352-361 (2006)).

The reaction mixtures of EcoRI and oligonucleotides are electrophoresed in 10% polyacrylamide minigels (acrylamide:bis-acrylamide=29: 1), TAE buffer (40 mM Tris, 20 mM acetic acid, 1 mM EDTA, pH 8.3) with triethylene glycol. Samples are loaded on the gel at 150-200 V, and run for ˜1 hour. The neutral solutes triethylene glycol and glycerol are added to the acrylamide gel mix before polymerization is initiated by ammonium persulfate and tetramethylethylenediamine (TEMED). These neutral solutes do not interfere with the polymerization reaction. The pH of the TAE buffer decreases from 8.25 with no added neutral solute to 8.05 with 30% triethylene glycol. To minimize loss of neutral solute in the gel by diffusion, triethylene glycol and glycerol are also added to the sample wells as soon as the gel is immersed in the electrophoresis buffer.

Electrophoretic bands containing free DNA and DNA-protein complex are stained with the fluorescent dye SYBR Green I (Invitrogen™) for 20-30 minutes. Longer times lead to loss of oligonucleotide from the gel. The gels are imaged with a FLA-3000 Fluorescent Image Analyzer (Fuji Film). The FLA-3000 is interfaced to a Pentium® PC.

This example demonstrated a method of separating a complex comprising a first agent bound to a second agent from unbound agent.

### EXAMPLE 2

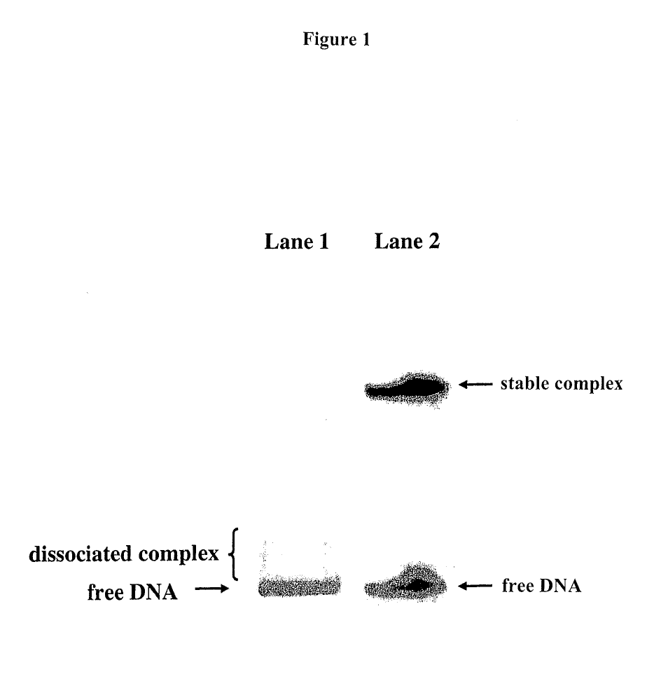

Polyacrylamide gels are prepared as described in Example 1 either without neutral solute or with 30% triethylene glycol. The reaction mixture of EcoRI and the non-specific oligonucleotide of Example 1 are electrophoresed and the electrophoretic bands are stained and imaged as described in Example 1. The results are shown in FIG. 1.

Lane 1 of FIG. 1 shows a 10% polyacrylamide gel in standard TAE buffer with no neutral solute added. As shown in Lane 1 of FIG. 1, the complex of protein bound to a nonspecific sequence oligonucleotide simply gives a smear in the gel, indicating dissociation of the complex in the gel.

Lane 2 of FIG. 1 shows a 10% polyacrylamide gel in standard TAE buffer with 30% triethylene glycol added. As shown in Lane 2 of FIG. 1, the complex of protein bound to a nonspecific sequence oligonucleotide gives a clearly distinguishable band, indicating stabilization of the bound complex in the gel.

This example demonstrated that a gel comprising a neutral solute stabilizes a protein-nonspecific DNA complex in the gel and provides a more clearly distinguishable separation from unbound agents than a gel that does not comprise a neutral solute.

### EXAMPLE 3

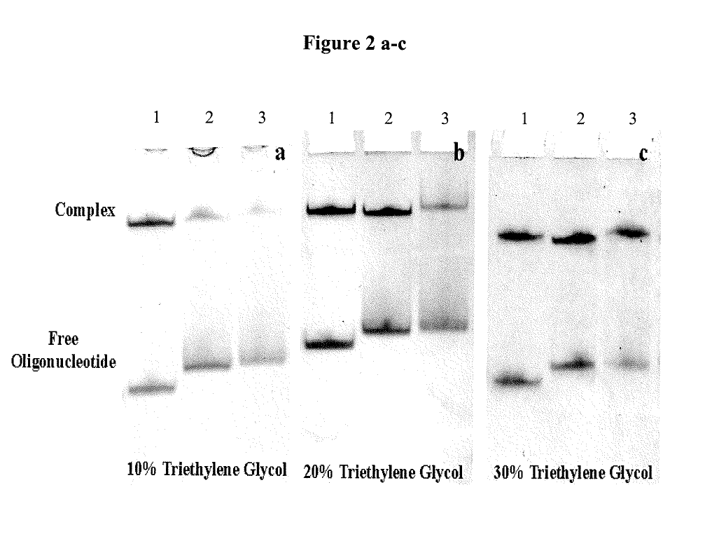

Polyacrylamide gels are prepared as described in Example 1 with 10%, 20%, or 30% triethylene glycol. The reaction mixture of EcoRI and the specific (Lane 1), ‘star’ (Lane 2), and nonspecific (Lane 3) oligonucleotides of Example 1 are electrophoresed and the electrophoretic bands are stained and imaged as described in Example 1. The results are shown in FIGS. 2(a)-(c).

The ‘star’ and nonspecific sequence oligonucleotides are 30 bp long while the specific site oligonucleotide is only 24 bp, accounting for the difference in migration seen in the gel. Under the stoichiometric binding conditions of the reaction mix, about equal fractions of DNA are expected in the complex and free oligonucleotide bands. As shown in FIG. 2(a)-(c), the complexes of protein with specific (Lane 1), ‘star’ (Lane 2), and nonspecific (Lane 3) sequence oligonucleotides give a clearly distinguishable band, indicating stabilization of the bound complex in the gel with 10% (a), 20% (b), or 30% (c) triethylene glycol. Both the nonspecific and ‘star’ sequence complexes become more stable in the gel as the concentration of triethylene glycol is increased.

This example demonstrated that a gel comprising a neutral solute stabilizes a protein-nonspecific DNA complex and a protein-‘star’ sequence complex in the gel and provides clear separation from unbound agents.

### EXAMPLE 4

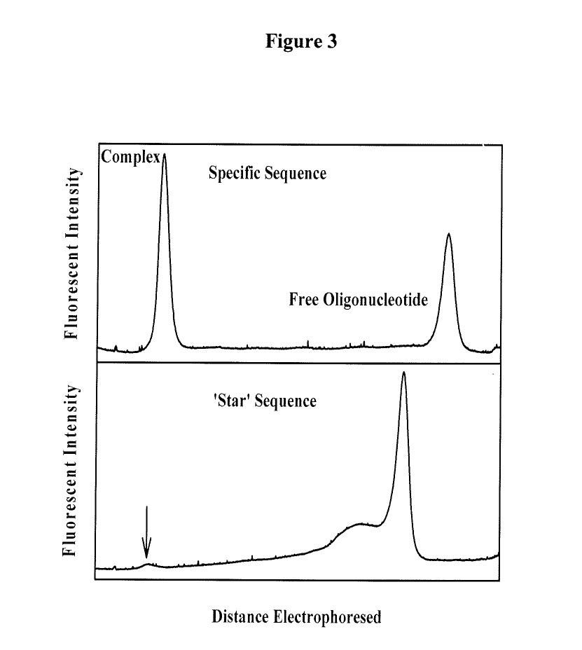

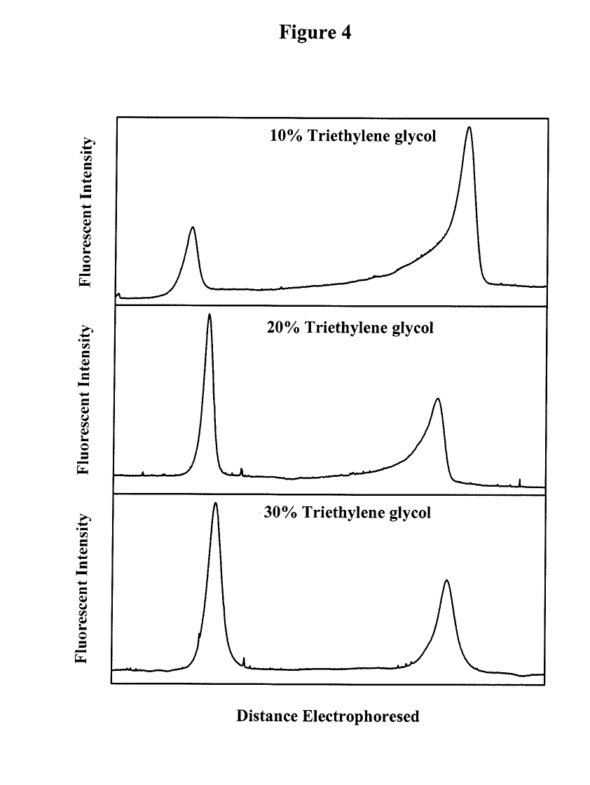

Polyacrylamide gels are prepared as described in Example 1 either without neutral solute or with 10%, 20%, or 30% triethylene glycol. The reaction mixture of EcoRI and the ‘star’ or the specific oligonucleotides of Example 1 are electrophoresed on a gel without neutral solute or with 10%, 20%, or 30% triethylene glycol as described in Example 1. The electrophoretic bands are stained and imaged as described in Example 1. Band intensities are quantified using the Fuji Film software MultiGauge for Windows. The linearity of oligonucleotides fluorescent staining is confirmed over the range of DNA concentrations studied. The results are shown in FIGS. 3 and 4.

The fluorescence intensity profiles along the lane for the specific and ‘star’ sequence oligonucleotides electrophoresed on a gel without neutral solute are shown in FIG. 3. The profile of the specific sequence complex (top panel) is typical of a stable, non-dissociating complex; the free and complex DNA bands are separated by a flat baseline. The fraction of oligonucleotide in the specific sequence complex is ˜0.5 as expected for stoichiometric binding and from the ratio of protein to DNA in the reaction mix. Most of the ‘star’ sequence complex (bottom panel), however, dissociates almost immediately upon entering the gel. The complex continues dissociating throughout the gel as seen by the decreasing background intensity between the free DNA band and the presumed position of the complex. The small blip indicated by the arrow in FIG. 3 (bottom panel) is all that is left of the complex at the end of the electrophoresis run. The lane profile does not depend on the neutral solute concentration of the sample in the well.

FIG. 4 shows a lane intensity profile for the ‘star’ sequence complex electrophoresed in a gel including 10% (top panel), 20% (middle panel), or 30% (bottom panel) triethylene glycol. At 10%, 20%, and 30% triethylene glycol, stabilization of the complex is improved as compared to electrophoresis of the ‘star’ sequence complex in a gel including no neutral solute (FIG. 3). At 30% triethylene glycol, the profile for the ‘star’ sequence complex appears to be that which is typical of a stable, non-dissociating complex; the free and complex DNA bands are separated by a flat baseline. At 30% triethylene glycol, the profile for the ‘star’ sequence complex appears to be comparable for the profile obtained for the specific sequence complex without neutral solute. The fraction DNA in the complex bands is ˜0.5 for all three oligonucleotides.

This example demonstrated that a gel comprising a neutral solute stabilizes a protein-‘star’ sequence complex in the gel and provides clear separation from unbound agents.

These Examples demonstrate that including the neutral solute triethylene glycol in the gel stabilizes weak noncognate and nonspecific complexes of EcoRI for analysis. Without neutral solute, both ‘star’ and nonspecific sequence complexes dissociate too quickly in 10% polyacrylamide gels. These Examples show that 10-30% triethylene glycol in the gel (equivalent to ˜4.3 osmolal) is enough to stabilize complexes that have association binding constants at regular salt and pH conditions in the range of about 10⁵ to about 10⁶ M⁻¹.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method of separating unbound agents from a complex comprising a first agent bound to a second agent comprising
(a) preparing a gel comprising a gel matrix and a neutral solute selected from the group consisting of stachyose, a glucoside, an amine oxide, a betaine, triethylene glycol, sorbitol, ethylene glycol, threitol, xylitol, and ectoine,
(b) placing one or more samples comprising the complex and unbound agents on the gel, and
(c) applying an electrophoresis voltage across the gel and separating the complex from the unbound agents.

2. The method according to claim 1, further comprising determining the degree of migration of the complex on the gel.

3. The method according to claim 1, further comprising collecting the separated complex and/or the separated unbound agents.

4. The method according to claim 1, wherein the neutral solute is triethylene glycol.

5. The method according to claim 1, wherein the first and second agents are selected from the group consisting of a protein, a nucleic acid, a drug, a ligand, and a target molecule.

6. The method according to claim 1, wherein the gel comprises from about 10% to about 50% neutral solute.

7. The method according to claim 1, wherein the neutral solute is triethylene glycol and the gel comprises from about 20% to about 30% neutral solute.

8. A method of separating unbound agents from a complex comprising a first agent bound to a second agent by chromatography comprising
(a) preparing a stationary phase comprising a neutral solute selected from the group consisting of stachyose, a glucoside, an amine oxide, a betaine, triethylene glycol, sorbitol, ethylene glycol, threitol, xylitol, and ectoine,
(b) combining a mobile phase with a sample comprising the complex and unbound agents,
(c) placing the mobile phase comprising the sample in the stationary phase, and
(d) moving the mobile phase through the stationary phase and separating the complex from the unbound agents by chromatography.

9. The method according to claim 8, further comprising collecting the separated complex and/or the separated unbound agents.

10. The method according to claim 8, wherein the neutral solute is triethylene glycol.

11. The method according to claim 8, wherein the first and second agents are selected from the group consisting of a protein, a nucleic acid, a drug, a ligand, and a target molecule.

12. The method according to claim 8, wherein the stationary phase comprises from about 10% to about 50% neutral solute.

13. The method according to claim 8, wherein the neutral solute is triethylene glycol and the stationary phase comprises from about 20% to about 30% neutral solute.

14. A method of separating unbound agents from a complex comprising a first agent bound to a second agent by capillary electrophoresis comprising
(a) preparing a buffer comprising a neutral solute selected from the group consisting of stachyose, a glucoside, an amine oxide, a betaine, triethylene glycol, sorbitol, ethylene glycol, threitol, xylitol, and ectoine,
(b) placing the buffer in a capillary of a capillary electrophoresis apparatus,
(c) placing a sample comprising the complex and unbound agents in capillary,
(d) applying an electrophoresis voltage along the capillary and separating the complex from the unbound agents by capillary electrophoresis.

15. The method according to claim 14, further comprising collecting the separated complex and/or the separated unbound agents.

16. The method according to claim 14, wherein the neutral solute is triethylene glycol.

17. The method according to claim 14, wherein the first and second agents are selected from the group consisting of a protein, a nucleic acid, a drug, and a ligand.

18. The method according to claim 14, wherein the buffer comprises from about 10% to about 50% neutral solute.

19. The method according to claim 14, wherein the neutral solute is triethylene glycol and the buffer comprises from about 20% to about 30% neutral solute.
